(19) United States
(12) Patent Application Publication
(10) Pub. No.: US 2005/0116985 A1
(43) Pub. Date: Jun. 2, 2005

(54) High-precision liquid droplet dispenser

(75) Inventor: Martin Schurenberg, Tarmstedt (DE)

Correspondence Address: KUDIRKA & JOBSE, LLP, ONE STATE STREET, SUITE 800, BOSTON, MA, 02109, US

(73) Assignee: Bruker Daltonik GMBH, Bremen (DE)

(21) Appl. No.: 10/975,027

(22) Filed: Oct. 27, 2004

(30) Foreign Application Priority Data
Oct. 30, 2003 (DE) 103 50 614.4

(51) Int. Cl. B41J 2/165

(52) U.S. Cl. 347/27

(57) ABSTRACT

A liquid droplet dispenser generates very small droplets of regular size and high velocity by means of shock waves in a liquid-filled capillary. The droplets are ejected from an ejection capillary. The ejection capillary is surrounded by one or more capillary tubes, which create liquid surfaces that allow the droplets to be ejected on a stable path along the axis of the ejection capillary. A system of multiple ejection capillaries may be used that may be fed from a common liquid reservoir. The dispenser may be used for surface coating, as well as other applications.

### FIELD OF THE INVENTION

This invention relates to the field of high-velocity liquid droplet dispensing using shock waves in a liquid-filled capillary.

### BACKGROUND OF THE INVENTION

Liquid dispensers are used to permit the transfer of accurately measured quantities of liquid without contact. The transfer takes place in the form of tiny droplets of exactly the same size. It is possible here for the liquid to be pipetted into containers, for instance into microtitre plates; they can, however, also be applied to surfaces, as happens, for instance, in printing heads. A further example is the transfer of an accurately measured quantity of matrix substance onto the surface of matrix assisted laser desorption and ionization (“MALDI”) targets for mass spectrometry.

The dispensers generate shock waves, usually through a very rapid change in volume. This shock wave travels at the speed of sound down the central capillary to its tip, where a tiny droplet is catapulted out of the surface. The change in volume can be created either through changes in the voltage applied to an electrostrictive material in a suitably shaped chamber (“piezo-dispenser”), through the sudden generation of a vapor bubble (“bubble jet”), or by a magnetic field generated by a coil acting on a magnetostrictive material (“solenoid dispenser”). The size of the droplets depends on the device, but is generally very small: it contains a few tens to a few hundred picolitres. The diameter of the droplets is a few tens of micrometers. Under conditions of steady operation, which can involve a frequency of some tens to some tens of thousands of Hertz, very uniformly sized droplets are created.

A feature common to all dispensers is that the flight direction of the generated droplets cannot be predicted exactly, because it depends on the microscopic geometrical relationships at the tip of the capillary. Uneven wetting of the capillary tip with the dispensing liquid, or tiny irregularities at the edge of the dispenser tip, result in flight paths that are no longer oriented precisely along the axis of the ejection capillary. For aqueous dispensing liquids, in which the substances may be dissolved at levels far below saturation, the direction of successive droplets remains the same for quite long periods (minutes to hours). But here too, the manufacture of very evenly machined, polished edges to the tips of the dispenser capillaries calls for considerable effort.

The relatively consistent flight direction often suffers when using dispensed liquids with high or predominating proportions of organic solvents, in which it is also possible for substances to be dissolved at levels close to saturation. Drying of the dispenser liquid at the wetting edge can easily lead to the formation of a smear film, or even crystals, at the edge of the dispenser tip, and these will determine the direction of the flight path. Changes in the wetting resulting from asymmetrical creep of the liquids to the outside of the capillary tip also cause changes in the flight direction.

Elegant solutions to the problem of measuring the flight direction are known for single dispensers of aqueous solutions. For instance, the dispensers, which are most often mounted on equipment that provides x-y motion, can be moved up to equipment having thin wires arranged transverse to the x and y directions; a sound is generated when the ejected droplets contact the wires and is detected by sensitive microphones attached to the wires. In this way, individual dispensers can be repeatedly calibrated very quickly. When organic solvents are used, however, this kind of calibration is not very helpful, as stable operation does not occur even for relatively short times.

In some cases, such as that of printer heads, which are located very close to the surface of the paper to be printed, the flight direction plays a subsidiary role. In other cases, however, such as the application of matrix material to a large number of small spots on a MALDI sample carrier plate with highly accurate positioning, the unpredictable flight directions prevent such dispensers from being used successfully, particularly because in most cases, for a variety of reasons, a relatively large distance must be maintained between the sample carrier plate and the dispenser tip. In particular, moreover, the manufacture of multiple dispensers for the simultaneous application of material to a large number of fields with highly accurate positioning is completely impossible.

The precise mechanisms determining the direction taken by the droplets are not known in detail. We can assume that the flight direction of the droplets depends on the angle at which the shock wave strikes the surface of the liquid. If this angle is precisely 90°, the droplets will fly away from the surface at an accurately perpendicular angle. The force required to pull the droplet away from the surface acts in the same direction as the shock wave, and therefore does not affect the droplet's flight direction; the energy required for breaking away merely lowers the flight velocity in comparison with the velocity of the shock wave. If, however, the shock wave does not strike the surface of the liquid perpendicularly, the droplets will receive an impulse from the shock wave in the same direction as the shock wave, but the force required to break away from the surface will be at an angle to the shock wave. The breakaway force therefore changes the flight direction of the separated droplet which, in a manner similar to light refraction, will now emerge from the surface with a smaller angle of ejection than the shock wave's angle of incidence, each of these angles being measured with respect to the surface (see FIG. 1). In addition to this, the liquid droplets that break away from the surface within the tip of the ejection capillary can also be diverted by edge deposits on the inside of the capillary. As shown in FIG. 1, the angle of incidence, α, of the shock wave (3) to the surface of the liquid (1) is always larger than the angle of ejection, β, of the droplet, because the breakaway force diverts the droplet away from the direction of the shock wave (3) towards the flight direction (4).

### SUMMARY OF THE INVENTION

The idea of the invention is to provide a liquid meniscus stretching without disturbance entirely over and beyond the tip of the ejection capillary, by means of one or more capillaries positioned coaxially over the tip of the ejection capillary. The liquid meniscus will be oriented accurately perpendicular to the axis of the ejection capillary, and yields an accurate flight direction in the direction of the axis of the ejection capillary. In particular, the formation of crystals at the edge of the ejection capillary is prevented.

The liquid meniscus here is created by both capillary and wetting forces. For the wetting forces it is favorable if the tip of the ejection capillary is hydrophilic to the dispensing liquid used, on both the inside and the outside. It can also be favorable, when only one additional capillary is used, for it to be hydrophobic on the outside, so that the dispensing liquid cannot pull itself up the external surface. Furthermore, it is favorable (although not necessary) for the edge between the hydrophilic and hydrophobic surfaces of the outermost capillary to be sharp (if possible, more acute than merely 90°), because in that case the dispensing liquid has a further obstacle to reaching the external surfaces (since edges inhibit wetting). The shape of the capillary should cause the wetting to extend as far as the sharp edge, thus providing an edge for the liquid meniscus of the most uniform height possible, relatively far away from the axis of the inner capillary.

In another embodiment, the outer capillary can also be fully hydrophilic on both the inside and outside, and may even be rounded, in order to generate even wetting. In any case, small errors of shape, wetting faults or crystal formations at the outer capillary have far less influence on the direction of flight of the droplets than is the case in previous embodiments where the ejection capillary is the only capillary.

With multiple additional capillaries, the hydrophobic properties of the external wall and the formation of a sharp edge only applies to the outermost capillary. The inner capillaries, including the ejection capillary, should all have hydrophilic surfaces.

Allowing the liquid meniscus to extend in this way beyond the tip of the ejection capillary largely prevents crystallization at the tip of this capillary. This permits undisturbed operation for a much longer period of time than has been possible with prior embodiments. To achieve even longer periods of operation, it is favorable for each dispenser tip to be covered by a cap with a small hole through which the droplets may emerge, so that drying is suppressed.

Dispensers whose angle of emergence is effectively straight can be formed as multiple pipettes. Thus, for instance, an arrangement of 4×6=24 dispensers spaced 18 mm apart can be used to dispense matrix substances onto MALDI sample carriers with the format of microtitre plates; here, for 96 MALDI spots the dispenser must operate four times, while for 384 spots it must dispense 16 times.

### BRIEF DESCRIPTION OF THE DRAWINGS

The above and further advantages of the invention may be better understood by referring to the following description in conjunction with the accompanying drawings in which:

FIG. 1 illustrates the angular relationships as the droplet breaks away from a dispenser capillary.

FIG. 2 illustrates the principle of the invention of a dispenser tip having three concentric capillaries that together create a single liquid meniscus.

FIG. 3 represents a bank of three dispensers, each having an outer capillary surrounding the ejection capillary, with an electrorestrictive chamber, caps inhibiting evaporation, connecting tubes and a reservoir of adjustable height for the dispensing liquid.

FIGS. 4A and 4B show two dispensers for comparison purposes, one based on prior art technology (FIG. 4A) and one based on the present invention (FIG. 4B).

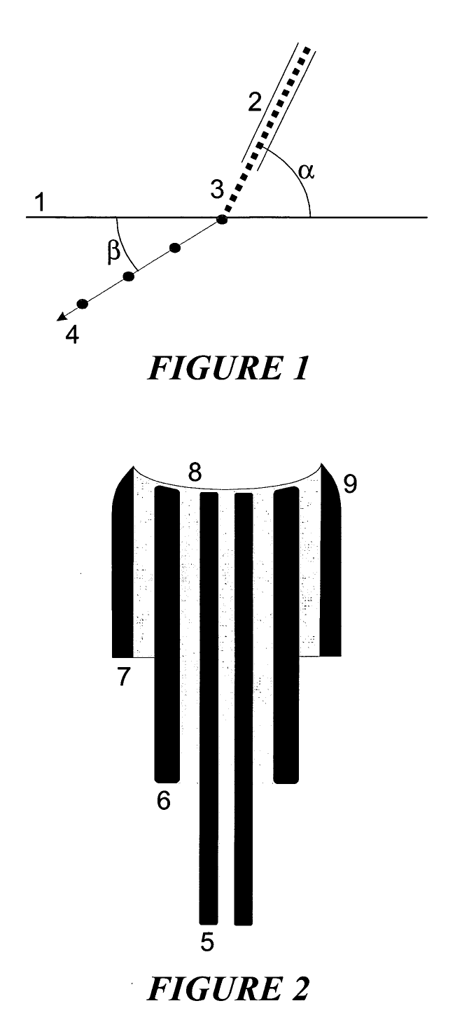

### DETAILED DESCRIPTION

As an example of a first embodiment, a single dispenser for applying spots of matrix substance to a MALDI sample carrier plate is described; it is, however, also suitable for an arrangement of multiple dispensers. It is the task of this equipment to create a large number of matrix spots, each having a thin layer of matrix substance. By way of example, the matrix substance here is alpha-cyano-4-hydroxy cinnamic acid (ACH) mixed with a proportion of cellulose nitrate. The cellulose nitrate functions here as a strong adhesive for the tiny crystals of ACH which form, as a strongly adsorptive binder for the organic biomolecules which will later be applied from an aqueous solution, and also as an explosive that will generate a small plasma cloud with which even the large biomolecules are transferred to the gaseous state. The ACH functions as a proton donor for the biomolecules, i.e., it permits ionization. The cellulose nitrate can later be converted into a highly porous structure.

The sample carrier plate consists here of a substrate of metal or of electrically conductive plastic with a powerfully hydrophobic surface, which can be provided with hydrophilic anchor regions for the matrix spots. The sample carrier plate should preferably be the size of a microtitre plate, in order that the robot sample preparation equipment that has been commercially developed for these plates can be used. If provided with hydrophilic anchor regions, it is of particular importance to apply material only to these regions. But also when the application is to an entirely hydrophobic region, it remains important to make the application to accurately pre-defined locations having known coordinates.

ACH and cellulose nitrate are both soluble in acetone and in acetonitrile, and can therefore be applied to the sample carrier plate at the same time. However, since these solvents evaporate very quickly, a form of dispenser in accordance with the invention is of particular importance, because evaporation of the solution at a single dispenser capillary tip very quickly leads to a change in the geometry of the tip as a consequence of crystallization, so modifying the flight direction of the droplets. The solution always crystallizes at the edge of the wetted region, in other words precisely at the capillary tip. On the other hand, the solution of substances should not be far away from saturation, so that the applied micro-droplets can dry very quickly. In some cases it even appears to be favorable for the generation of an even film within the matrix spots if the droplets undergo a degree of stiffening due to crystallization even during their flight.

The matrix film in the matrix spot is created from a large number of droplets. If the droplet remains liquid until it impacts on the sample carrier plate, it is easily possible to apply about 100 droplets one after another. The small size of the droplets and the surface tension of the solution prevent splashing. The liquid then wets the desired small region of a few hundred micrometers diameter; for example, precisely one hydrophilic anchor site. In this way a high generation rate of several kilohertz can be utilized, so that application is completed in less than one tenth of one second. The ease with which the solvent evaporates means that the spot is dry in about three to five seconds. A sample carrier plate with 384 spots of matrix material can be coated in about one minute. In this case a single dispenser is usually sufficient to achieve a high production rate of pre-prepared MALDI plates.

For droplets that begin to stiffen during their flight, it is possible for a movement unit to create controlled relative movement between the dispenser units and the sample carrier plate. The droplets can then be aligned relatively close to one another. If the droplets have a diameter of about 60 micrometers, which corresponds to a volume of about 100 picolitres, then about 100 droplets are sufficient to coat a square matrix region with sides 600 micrometers in length. With a sufficiently fast movement unit and an ejection frequency of 100 drops per second, such a region can be treated in one second. Faster rates of coating are possible if the movement unit is fast enough. The optimum speed, however, is primarily determined by the drying behavior. In this case it is favorable to employ a multiple dispenser if a high production rate is to be achieved.

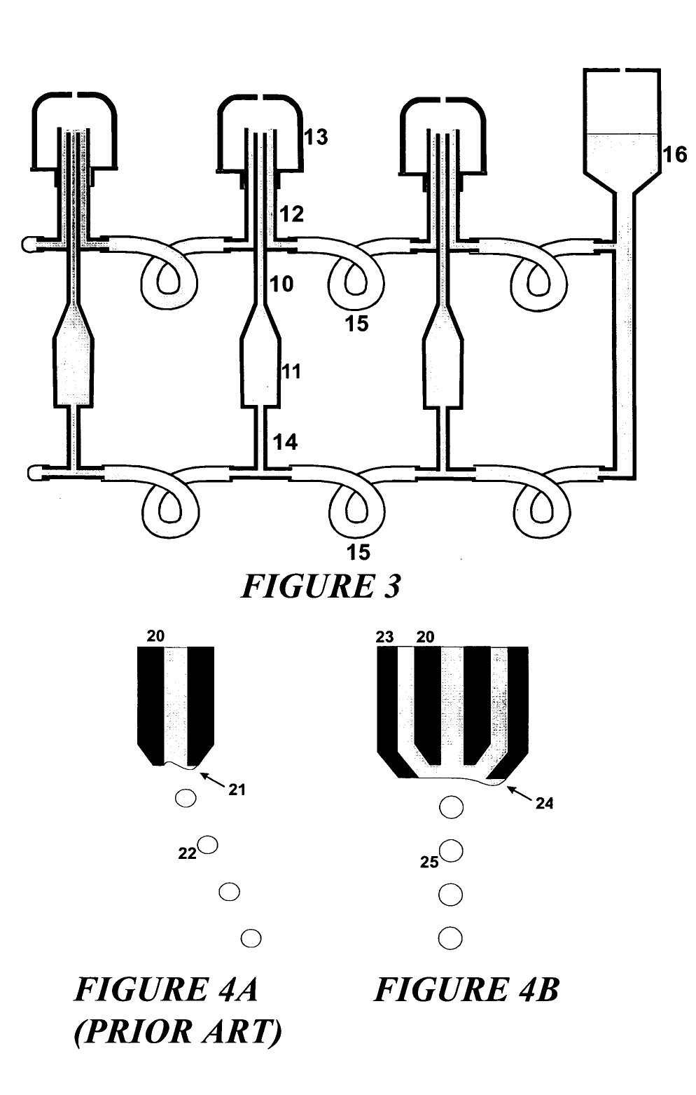

The single dispenser is, as shown in the example of FIG. 3 for a bank of dispensers, each equipped with a central ejection capillary (10) and a concentric external capillary (12). FIG. 3 represents a bank of three dispensers, each having an outer capillary (12) surrounding the ejection capillary (10), with an electrorestrictive chamber (11), caps inhibiting evaporation (13), connecting tubes (15) and a reservoir (16) of adjustable height for the dispensing liquid. It is, of course, also possible to use an arrangement of three concentric capillaries, as illustrated in the example of FIG. 2. In FIG. 3, the central ejection capillary (10) is connected to a chamber (11) whose electrostrictive wall material allows it to be subjected to a rapid change in volume by electrical means (using a voltage pulse), as a result of which the shock wave arises in the ejection capillary (10). In other dispensers, the volume change may be generated with the aid of magnetostrictive material or through the abrupt creation of a vapor bubble. The chamber (11) can (but does not have to) be provided with a capillary (14) on the side opposite to the ejection capillary, thus permitting a continuous supply of the dispensing liquid. (The chamber can also be closed, and filled just once with water, oil, or another liquid that propagates the shock wave, in which case the supply of dispensing liquid takes place through a surrounding concentric capillary.)

FIG. 2 illustrates the principle of the invention of a dispenser tip having three concentric capillaries (5), (6) and (7), that together create a single liquid meniscus (8). The outer surface (9) of the outer capillary (7) is hydrophobic, while all the other surfaces are hydrophilic. With multiple additional capillaries, as in the embodiment of FIG. 2, the hydrophobic properties of the external wall (9) and the formation of a sharp edge only applies to the outermost capillary (7). The inner capillaries (6), including the ejection capillary (5), should all have hydrophilic surfaces.

The central ejection capillary may also be rounded at its tip and, as mentioned above, is preferably hydrophilic both inside and outside. The coaxially mounted external capillary is preferably hydrophilic on the inside and hydrophobic outside. As shown in FIG. 2, as well as FIG. 3, it is helpful (but not necessary) if the inner capillaries (5, 6) do not reach all the way to the furthest tip of the outer capillary (7), in order to provide space for a liquid meniscus (8) that extends over all the internal capillaries (5, 6), and which is as nearly perpendicular as possible to the axis of the ejection capillary (5).

The liquid meniscus is created by the wetting of the capillary ends; its formation can additionally be finely adjusted by the feed pressure of the dispensing liquid. The intermediate spaces between the capillaries should be narrow, in order to permit replenishment of the liquid through capillary attraction. Although it may not be necessary to center the inner capillary within the outer capillary, an even spacing is used in the exemplary embodiment, so that the axis of the inner capillary is located in the center of the liquid meniscus. The clearance can be very small (less than one millimeter, preferably about half a millimeter) so that the liquid can be retained and guided between the capillaries through capillary attraction.

The diameter of the droplets rises slightly if the liquid meniscus is located some distance from the tip of the ejection capillary. As a small change in diameter is sufficient to create a large change in volume, the volume of the droplets can be varied within certain limits. This variation can be created by the external pressure applied to the dispensing liquid.

FIGS. 4A and 4B show two dispensers for comparison purposes, one based on prior art technology (FIG. 4A) and one based on the present invention (FIG. 4B). As shown, the droplets (22) from the ejection capillary (20) in the conventional arrangement of FIG. 4A without a surrounding capillary undergo a significant deviation in the flight path under the influence of even a slightly asymmetrical wetting (21) of the tip of the capillary. However, in the presence of the surrounding capillary (23) of the arrangement shown in FIG. 4B, an asymmetrical wetting (24) creates no noticeable deviation in the flight path of the droplets (25); although the droplets (25) are a little larger.

The terms “hydrophilic” and “hydrophobic” are used here to indicate whether the surface so described can or cannot be wetted by the dispensing liquid being used. In other words, the liquid in the capillary tube, or in the capillary slot between the concentric capillary tubes, should rise under the influence of capillary attraction to the tip, and should spread over all the hydrophilic surfaces by wetting them. This gives rise to a liquid meniscus which, if the capillary tips are arranged with reasonably good rotational symmetry, is axially perpendicular to the axis of the central ejection capillary. As this means that the tip of the ejection capillary does not have a wetting edge, crystallization does not occur here even if the solvent evaporates. If crystallization occurs at all, it will be at the outermost capillary, where the crystals scarcely have a noticeable effect on the flight direction of the droplets.

For longer periods of operation without cleaning it is favorable if the dispenser is provided with an air-tight cap (13) having only a small hole to allow the droplets to emerge. Saturation vapor pressure very quickly develops inside the cap, inhibiting further drying. As the flying droplets are very small, they start to dry even at the beginning of their flight against the saturated vapor pressure, because their tightly curved surface means that their vapor pressure is greater than the vapor pressure of the liquid meniscus. This compensates for the small amount of external air diffusing into the space inside the cap (13) through the ejection hole.

Even in the absence of a cap (13), a single dispenser of the sort shown provides much more stable dispensing than a dispenser having the prior form of implementation. The dispenser according to the invention can thus be used for many minutes without interruption. Operation for longer periods requires the dispensing tip to be cleaned from time to time, but this is a very easy task. The cleaning can, for instance, be performed by forcefully feeding pure solvent through the outer capillary. As it is usually the case that crystals only form at this capillary, cleaning of this sort is sufficient. Wiping the dispenser tip with a felt soaked in solvent can also provide adequate cleaning.

During operation of the dispenser, the concentric capillaries of a dispenser may be connected by tubes (15) to a reservoir (16) of dispensing liquid, i.e., a solution of the matrix substance mixture, as is shown in FIG. 3 for a bank of three dispensers. This reservoir (16) may have a height that is adjustable, and that can therefore be adjusted in such a way that the liquid meniscus at the dispenser tip is optimized for dispensing the droplets. In other modes of operation (for cleaning purposes, for instance) it can, however, also be useful to use different liquids in the three capillaries. In particular, flushing procedures at the tip of dispenser operation may make use of a variety of flushing liquids.

It is expedient to operate the dispenser in a vertical orientation. For application to a surface, however, the droplets can be ejected both downwards and upwards. The equipment shown here in FIG. 3 is arranged to eject droplets upwards so as to apply spots of matrix substance to the underside of a sample carrier plate mounted on a moving unit. The sample carrier plate and the movement unit are not shown here, as they are not essential to the invention. The droplets have a range of far more than ten centimeters in air at atmospheric pressure, but it is beneficial if they are not allowed to fly more than a few millimeters before impacting the sample carrier plate.

For many applications just the single dispenser illustrated here is sufficient, particularly because, as has been described above, it can be operated with droplet generation frequencies as high as several kilohertz.

FIG. 3 also shows how several of the single dispensers described, with one or two external capillaries, and with or without a cap (13), can be assembled into a bank. For rapid coating with low droplet generation frequencies, as is desirable for some applications, it is helpful to assemble a larger number of dispensers. For instance, 4×6=24 such single dispensers, spaced 18 mm from one another, can be used for application to a sample carrier plate with the microtitre format. In this case, for 96 matrix spots, precisely 4 dispensing procedures, each involving about 100 droplets, are necessary; for 384 matrix spots, 16 dispensing procedures are needed; for 1536 matrix spots, 64 dispensing procedures are needed. Allowing one second for each matrix spot, the sample carrier plate can have 1536 matrix spots applied in about one minute, whereas if a single dispenser were used under these relatively slow conditions, nearly half an hour would be required.

For this kind of “carpet” application it is necessary for the droplets to dry as quickly as possible after impact. In order for the droplets to dry as quickly as possible (so that the droplets do not simply all run together) it is helpful to heat the sample carrier plate before application, and to arrange for warm, well-filtered air to flow through the intermediate space between the sample carrier plate and the dispenser units (i.e. the covering caps). For this purpose, the dispensing unit can itself be provided with suitable air supply and discharge systems.

The advantages of the invention include more robust dispensing of problematic solutions than is possible than with single capillaries; even solutions close to the saturation concentration can be used. Manufacture of the capillaries is simplified, since the extreme precision in fabrication of the nozzle opening and the time-consuming surface treatment of the capillaries required for conventional dispensing capillaries are no longer necessary. Larger droplets may also be generated.

Those skilled in the art will recognize that, while the exemplary embodiment show and described herein applies to the creating of MALDI targets for mass spectrometry, the invention is equally applicable to dispensers used in other fields. These fields include, but are not limited to, inkjet printing, surface coating and many other applications that require an accurate and repeatable dispensing of liquid material. Those additional applications are considered to be within the scope of the present invention as defined by the appended claims.

1. A dispenser for the generation of small, fast moving droplets of dispensing liquid with a ejection capillary at the tip of which a shock wave pulls the droplets out of the liquid surface, wherein one or more capillaries are located concentrically over the tip of the ejection capillary, developing a meniscus of dispensing liquid which extends beyond the tip of the ejection capillary.

2. A dispenser according to claim 1 wherein an outermost capillary protrudes beyond the inner capillaries in the direction of a longitudinal axis of the ejection capillary.

3. A dispenser according to claim 2 wherein surfaces of the ejection capillary are hydrophilic.

4. A dispenser according to claim 3 wherein an outer surface of the outermost capillary is hydrophobic.

5. A dispenser according to claim 4 wherein there is a sharp edge between the hydrophilic interior surface side and the hydrophobic exterior surface of the outermost capillary.

6. A dispenser according to claim 1 wherein the dispenser tip is covered by a air-tight cap which has a small hole through which the droplets can emerge.

7. A dispenser according to claim 1 wherein the dispenser is a first dispenser assembled together with a plurality of other dispensers to form a multiple dispenser.

8. A dispenser according to claim 1 wherein different liquids are fed to the different capillaries.

9. A dispenser according to claim 8 wherein there is a liquid within the ejection capillary that is only used for forming and transmitting the shock wave, and that does not mix with the dispensing liquid.
